(19) United States
(12) Patent Application Publication
(10) Pub. No.: US 2022/0314425 A1
(43) Pub. Date: Oct. 6, 2022

(54) Braided Hammer Handle Assembly

(71) Applicants: Kaden Fontenot, Mamou, LA (US); Raymond Fontenot, Mamou, LA (US)

(72) Inventors: Kaden Fontenot, Mamou, LA (US); Raymond Fontenot, Mamou, LA (US)

(21) Appl. No.: 17/217,692

(22) Filed: Mar. 30, 2021

(51) Int. Cl. B25G 1/02

(52) U.S. Cl. CPC B25G 1/02

(57) ABSTRACT

A braided hammer handle assembly for reducing impact energy transferred from a tool to a user includes a head that has a striking surface to deliver a blow when the head is swung. The head has a handle hole extending therethrough and a handle extends through the handle hole in the head for swinging the head. The handle is comprised of a braided cable such that the handle is resiliently flexible. In this way the handle can absorb impact energy when the head strikes an object thereby enhancing comfort for a user. A grip is positioned around the handle to enhance comfort for the user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to braided handle devices and more particularly pertains to a new braided handle device for reducing impact energy transferred from a tool to a user. The device includes a head and a handle which is comprised of a braided cable. Moreover, the braided cable is resiliently flexible thereby facilitating the braided cable to flex and absorb impact energy. In this way handle reduces the impact energy that is transferred to the user.

### (2) Description of Related Art Including Information Disclosed Under 37 CFR 1.97 and 1.98

The prior art relates to braided handle devices including a plurality of hammer handles that each has a flexible section defined by a braided cable or a coil for absorbing impact energy. Additionally, the prior art discloses a hammer handle that has a pivoting section for absorbing impact energy.

### BRIEF SUMMARY OF THE INVENTION

An embodiment of the disclosure meets the needs presented above by generally comprising a head that has a striking surface to deliver a blow when the head is swung. The head has a handle hole extending therethrough and a handle extends through the handle hole in the head for swinging the head. The handle is comprised of a braided cable such that the handle is resiliently flexible. In this way the handle can absorb impact energy when the head strikes an object thereby enhancing comfort for a user. A grip is positioned around the handle to enhance comfort for the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a braided hammer handle assembly according to an embodiment of the disclosure.

FIG. 2 is a front view of an embodiment of the disclosure.

FIG. 3 is a back view of an embodiment of the disclosure.

FIG. 4 is a right view of an embodiment of the disclosure.

FIG. 5 is a top view of an embodiment of the disclosure.

FIG. 6 is a cross sectional view taken along line 6-6 of FIG. 2 of an embodiment of the disclosure.

### DETAILED DESCRIPTION OF THE INVENTION

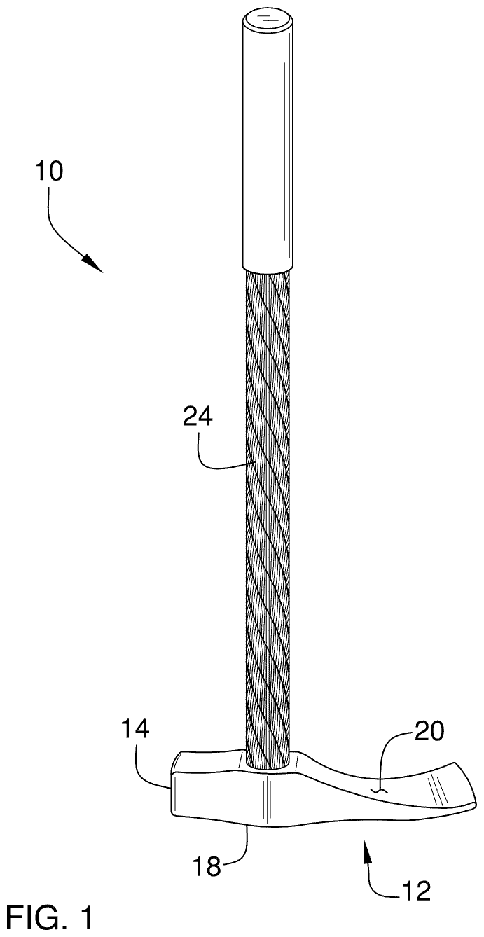

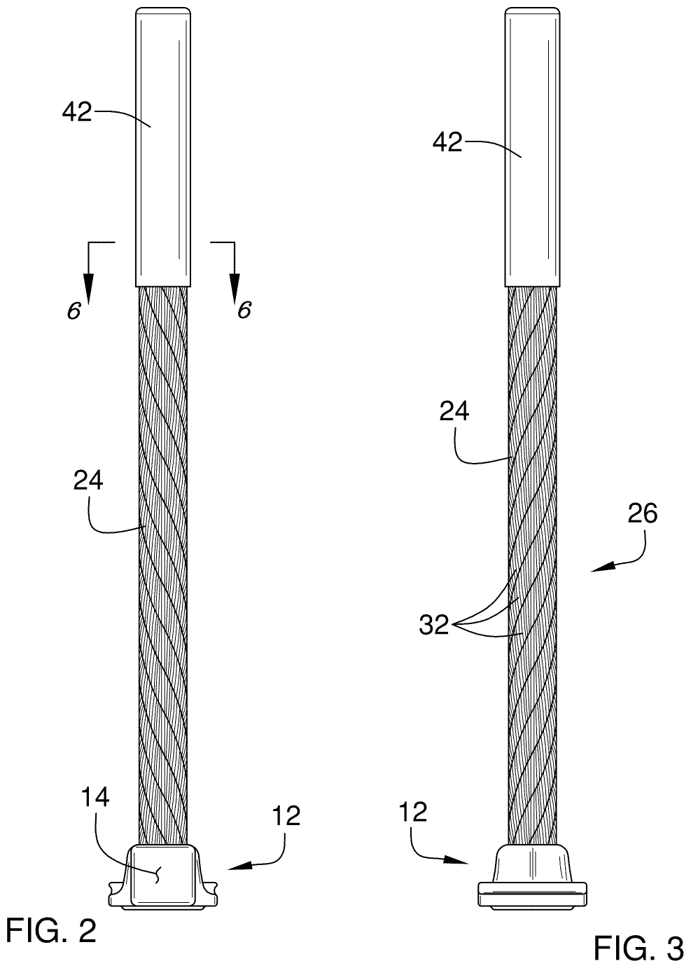

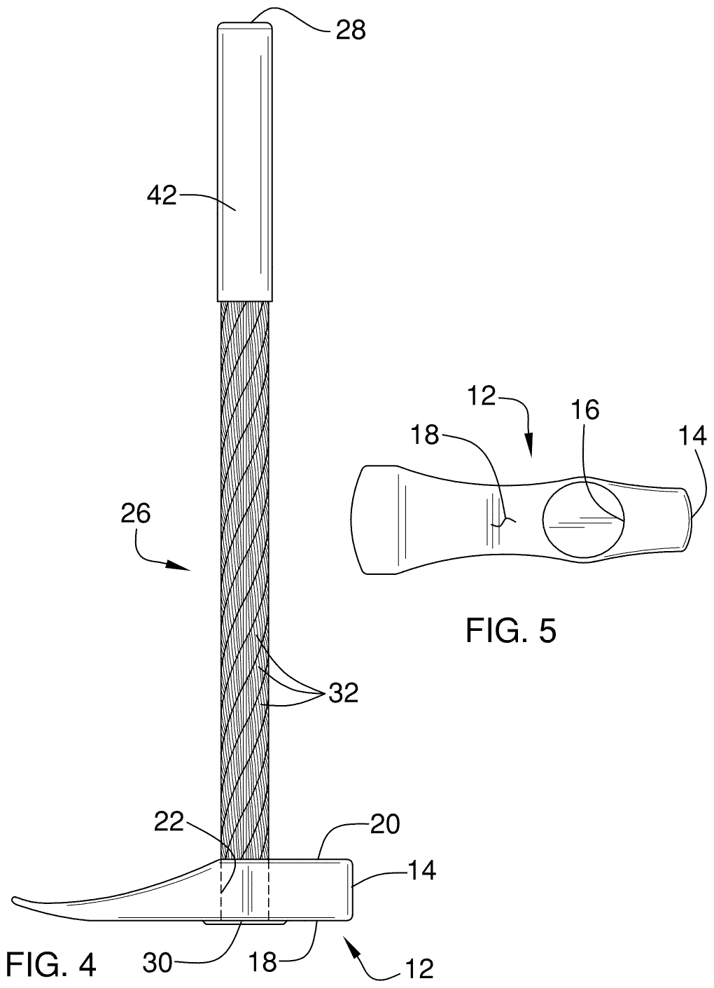

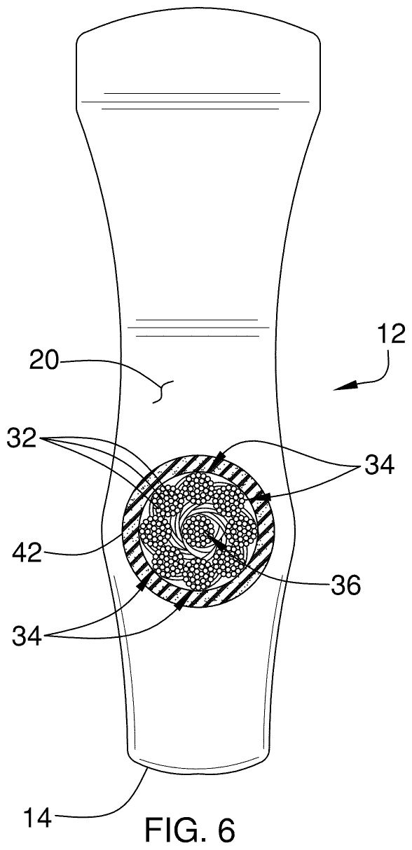

With reference now to the drawings, and in particular to FIGS. 1 through 6 thereof, a new braided handle device embodying the principles and concepts of an embodiment of the disclosure and generally designated by the reference numeral 10 will be described.

As best illustrated in FIGS. 1 through 6, the braided hammer handle assembly 10 generally comprises a head 12 that has a striking surface 14 formed therein. The striking surface 14 delivers a blow when the head 12 is swung. The head 12 has a handle hole 16 extending therethrough and the head 12 has a top surface 18 and a bottom surface 20. The striking surface 14 extends between the top surface 18 and the bottom surface 20. The handle hole 16 extends through the top surface 18 and the bottom surface 20, and the handle hole 16 has a bounding surface 22. The head 12 may be a sledge hammer head, an axe head, a splitting maul or any other type of metal head for striking. Additionally, the head 12 may have a weight ranging between approximately 4.5 kg and 7.0 kg.

A handle 24 is provided and the handle 24 extends through the handle hole 16 in the head 12 such that the handle 24 can be gripped for swinging the head 12. The handle 24 is comprised of a braided cable 26 such that the handle 24 is resiliently flexible. In this way the handle 24 can absorb impact energy when the head 12 strikes an object thereby enhancing comfort for a user. The braided cable 26 may comprise steel braided cable with a length ranging between approximately 30.0 cm and 120.0 cm.

The handle 24 has a lower end 28 and an upper end 30, and the braided cable 26 comprises a plurality of strands 32. The plurality of strands 32 includes a set of outward strands 34 and a central strand 36. Each of the strands 32 in respective ones of the outward strands 34 is twisted around each other such that each of the set of outward strands 34 forms a braided cable. Additionally, each of the strands 32 in the central strand 36 is twisted around each other such that the central strand forms a braided cable.

Each of the outward strands 34 is twisted around the central strand 36 between thereby defining the handle 24. The upper end 30 of the handle 24 is aligned with the top surface 18 of the head 12. The handle 24 might be welded to the head 12 or otherwise bonded to the bounding surface 22 of the handle hole 16 such that the handle 24 is permanently attached to the head 12. A grip 42 is positioned around the handle 24 such that the grip 42 can be gripped by a user. The grip 42 is comprised of a resiliently compressible material to enhance comfort for the user. Additionally, the grip 42 extends from the lower end 28 toward the upper end 30.

In use, the handle 24 is gripped and the head 12 is swung for striking. The handle 24 flexes when the head 12 strikes a work object thereby absorbing the impact energy of the head 12 striking the work object. In this way the user does not have to absorb the impact energy as is the case when using a rigid handle to swing a hammer or the like. Thus, the user does not fatigue as quickly when the user has to repeatedly employ the head 12 for striking.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A braided hammer handle assembly for absorbing shock produced when striking a hammer, said assembly comprising:
a head having a striking surface being formed therein wherein said striking surface is configured to deliver a blow when said head is swung, said head having a handle hole extending therethrough;
a handle extending through said handle hole in said head wherein said handle is configured to be gripped for swinging said head, said handle being comprised of a braided cable such that said handle is resiliently flexible wherein said handle is configured to absorb impact energy when said head strikes an object thereby enhancing comfort for a user; and
a grip being positioned around said handle wherein said grip is configured to be gripped by a user, said grip being comprised of a resiliently compressible material wherein said grip is configured to enhance comfort for the user.

2. The assembly according to claim 1, wherein said handle has a lower end and an upper end, said braided cable comprising a plurality of strands, said plurality of strands including a set of outward strands and a central strand, each of said strands in respective ones of said outward strands being twisted around each other such that each of said set of outward strands forms a braided cable, each of said strands in said central strand being twisted around each other such that said central strand forms a braided cable.

3. The assembly according to claim 2, wherein each of said outward strands is twisted around said central strand between said upper end and said lower end of said handle, said upper end of said handle being aligned with a top surface of said head.

4. The assembly according to claim 1, wherein:
said head has a top surface and a bottom surface, said striking surface extending between said top surface and said bottom surface, said handle hole extending through said top surface and said bottom surface, said handle hole having a bounding surface; and
said assembly includes a gasket forming a continuous ring, said gasket having said handle extending therethrough, said gasket being aligned with an upper end of said handle, an outer surface of said gasket abutting said bounding surface of said handle hole in said head, said gasket being comprised of a resiliently compressible material thereby facilitating said gasket to be compressed between said handle and said bounding surface of said handle hole for retaining said handle in said handle hole.

5. A braided hammer handle assembly for absorbing shock produced when striking a hammer, said assembly comprising:
a head having a striking surface being formed therein wherein said striking surface is configured to deliver a blow when said head is swung, said head having a handle hole extending therethrough, said head having a top surface and a bottom surface, said striking surface extending between said top surface and said bottom surface, said handle hole extending through said top surface and said bottom surface, said handle hole having a bounding surface;
a handle extending through said handle hole in said head wherein said handle is configured to be gripped for swinging said head, said handle being comprised of a braided cable such that said handle is resiliently flexible wherein said handle is configured to absorb impact energy when said head strikes an object thereby enhancing comfort for a user, said handle having a lower end and an upper end, said braided cable comprising a plurality of strands, said plurality of strands including a set of outward strands and a central strand, each of said strands in respective ones of said outward strands being twisted around each other such that each of said set of outward strands forms a braided cable, each of said strands in said central strand being twisted around each other such that said central strand forms a braided cable, each of said outward strands being twisted around said central strand between thereby defining said handle, said upper end of said handle being aligned with said top surface of said head; and
a grip being positioned around said handle wherein said grip is configured to be gripped by a user, said grip being comprised of a resiliently compressible material wherein said grip is configured to enhance comfort for the user, said grip extending from said lower end toward said upper end.
